(19) United States
(12) Patent Application Publication
(10) Pub. No.: US 2011/0017678 A1
(43) Pub. Date: Jan. 27, 2011

(54) Process for Rain Water, HVAC Condensate and Refrigeration Blowdown/Bleed Blowdown/Bleed Water Recovery, Water Quality Monitoring, Real Time Water Treatment and Utilization of Recovered Water

(76) Inventors: Dennis M. Anderson, Carson City, NV (US); Devon Eric Anderson, Carson City, NV (US)

Correspondence Address: Dennis M. Anderson, 3990 Timberline Dr., Carson City, NV, 89703, US

(21) Appl. No.: 12/840,894

(22) Filed: Jul. 21, 2010

Related U.S. Application Data
(60) Provisional application No. 61/271,603, filed on Jul. 23, 2009.

(51) Int. Cl. C02F 9/02; B01D 65/00; C02F 1/00; G05B 19/00

(52) U.S. Cl. 210/747; 210/138; 210/141; 210/85

(57) ABSTRACT

The present invention includes capturing water from rain, HVAC condensate and refrigeration blowdown/bleed blowdown that is recycled and reutilized in integrated mechanical processes. Water is monitored for volume, flow rate, and contaminants; and automatically cleaned through filtration and/or chemical and/or biological treatment techniques to meet acceptable health and safety standards for engineered end uses. The process components are integrated into an engineered system that includes: 1) water collection from air conditioning and refrigeration units and rain water; 2) custom design, engineering and implementation of a real time and/or scheduled water monitoring for water volume and water quality; 3) custom design, engineering and implementation of a real time and/or scheduled water treatment system to ensure water quality standards are met with respect to the end use of the recovered water; and 4) utilization of the recovered water by an engineered water distribution system.

### CROSS REFERENCES RELATED TO PATENT DOCUMENTATION

This application is cross-referenced to the provisional patent application with title Process for Rain Water, HVAC Condensate and Refrigeration Blowdown/Bleed Blowdown/Bleed Water Conservation, Reutilization, Treatment, and Irrigation as filed with the United States Patent and Trademark Office. The Application No. is 61/127,603 and filing date of the provisional patent application is 23 Jul. 2009. The present patent application requests priority-filing date of 23 Jul. 2009.

### FIELD OF THE INVENTION

The invention is fully integrated equipment and process technologies for rain water, heating, ventilation and air-conditioning (HVAC) condensate and refrigeration blowdown/bleed water collection, conservation, and reutilization coupled with an irrigation system and other uses. Captured water from rain, HVAC condensate and refrigeration blowdown/bleed water is recycled and reutilized in mechanical processes as a conservation technology. The water is continuously monitored for contaminants and automatically cleaned though filtration and chemical treatment to meet health and safety acceptable standards for irrigation use. The water is stored in the equipment and ultimately directed to efficient landscape irrigation uses, groundwater recharge, or other uses as needed. The tanks that are used for the water collection may be located above ground or underground.

The present invention includes the integrated components of: the water collection system, the water storage vessels, the water recycling system, the water quantity and quality monitoring system, the water sediment filtering system, the water cleaning system, and the distribution of the water to the end uses. The water recycling system will employ monitoring techniques to ensure that the recycled water containment levels remain below the use threshold. The water cleaning system may include advance micro-filtering and chemical treatment. The water storage and treatment tanks may be a series of tanks connected by plumbing or a single large tank with isolated cells to segregate the water based on water quality and distribution uses.

The present invention includes the integration of the following components into a novel engineered system:
1 Water collection from air conditioning and refrigeration units and rain water
2 The custom design, engineering and implementation of a real time or scheduled water monitoring system to ensure water quality standards are met with respect to the end use of the recovered water and to measure water quantity stored, used and flow rate.
3 The custom design, engineering and implementation of a real time or scheduled or as needed water treatment system to ensure water quality standards are met with respect to the end use of the recovered water.
4 Utilization of the recovered water to the engineered industrial, commercial or private use.

Depending on quality of the captured water and the end use criteria, the present invention is dynamic in applications and may use all or some of the available monitoring and treatment technologies to achieve the desired end objective of water quality that will meet or exceed the regulatory and practical end use water quality standards.

### BACKGROUND OF THE INVENTION

### Water Conservation

Water conservation is the process of reducing the amount of water used for day-to-day activities; it is by definition “the utilization of cost-effective water use efficiency practices to curtail the waste of water and to ensure that water use does not exceed reasonable needs.” Three good sources of water that are not being fully utilized are air conditioning condensate, refrigeration condensate, and rainwater. The condensate can provide fairly steady sources of relatively pure water; they are limited primarily by the cost of capturing the water.

### Water Sources and Water Collection

### Collection of Rainwater For Irrigation

Rain water can be collected at the surface for use at a later stage, especially in areas where there is scarcity. Today, many governments all over the world are funding and installing rain water collection systems for primary human use and for irrigation. The water management systems that different regions adopt are unable to meet the growing demands of the world population.

The systems are marketed as customizable barrels, cisterns or tanks. They can be custom built and integrated within any terrain. The engineering of the system to collect rain water for irrigation involves basic storage of the surface water and re-routing the water to the irrigation end use. The rain water for irrigation is collected in the main tank via a dedicated piping system. The water is then filtered of debris and is taken via down-spouts to the required area. The collected rain water is directed to irrigation purposes.

The collected rain water can be stored either on the surface or underground. The manufacturers of the rain-water-for-irrigation systems use material that is completely safe and suitable for the purpose to be served. The volume of water to be held, the length of piping required, the terrain and the material used are factors that influence the price of the rain water for irrigation systems. In commercial settings, sediment and petroleum products sometime are collected by rain water during run off. These contaminants can be managed by oil-water separators.

When it is necessary to remove oil from water, coalescing plate module type oil-water separators are often a good method because they remove the oil using only gravity for motive force, the separator modules are permanent and require little maintenance, no absorbents or other consumable items such as filter cartridges are required, and the oil that is separated is often recyclable. No pumping or other utility costs are usually required (although pumped systems can be designed if this is required by the site conditions). They can be designed to operate under a great range of operating conditions. Separator systems can often be located underground, thus minimizing waste of valuable area on the surface.

Because oil-water separators operate using gravity as the operating principle, their design is more difficult and requires more expertise than design of filtration or other systems that operate under pressure, but the ongoing benefits of low operating and maintenance costs and the sale of recyclable oil usually outweigh the slight added expense of the initial designs. No absorbents are required, so disposal costs are limited only to the disposal of the recovered oil.

### HVAC System Condensate Recovery

Cooling systems rely on evaporator coils through which refrigerant fluid changes from liquid to vapor, cooling the coils in the process. Air blowing past the coils cools off as it goes by, and moisture from the air condenses on the coils. Condensate drains carry away the water, usually into the sewer. Instead of wasting it, more and more building owners, especially in parts of the country with hot, humid weather, are capturing that condensate for reuse. In large commercial buildings, condensate recovery often produces enough water to supply all of the landscape irrigation needs for the property or a significant portion of makeup water for cooling towers.

The quantity of condensate water produced depends on the temperature and humidity conditions (both outdoors and indoors) and the amount of cooling being provided. While HVAC condensate is inherently pure, it is essentially distilled water. There is potential for contamination, especially if it sits in a warm environment. For this reason, chlorine may be used to treat condensate if necessary.

### Cooling-Tower Blowdown

A third source of available water is from cooling towers through evaporation and drift losses. The water that is drained from cooling equipment to remove mineral build-up is called “blow-down” water or “bleed” water. The cooling equipment that requires blow-down is most often: cooling towers, evaporative condensers, evaporative coolers, evaporative cooled air-conditioners, and central boilers (both steam and hot water). These cooling systems rely on water evaporation to garner the cooling effect (latent heat of evaporation). As the water evaporates, the mineral content (calcium carbonate, magnesium, sodium, salts, etc) of the remaining water increases in concentration of minerals. If left undiluted, these minerals will cause scaling on equipment surfaces; possibly damaging the system. The blow-down water is usually dumped into the sanitary drain, yet in some cases, this water can be reused for irrigation and other selected uses.

Water is also intentionally drawn off because minerals and other contaminants become more concentrated as a result of evaporation; a process referred to as blowdown. Typically, the blowdown water is drained into sewer lines, but it can be collected and reused for applications where the salinity or mineral content is acceptable.

When blowdown water is being reused, the “cycles of concentration” (a measure of how concentrated the mineral content of the water becomes due to evaporation) should not exceed two or three. Research by the San Antonio Water System, which has been using blowdown water for several years, has documented no less than four cycles of concentration with no ill effects on the plants (though there may be additional dilution from groundwater that is also captured in French drains).”

It is also possible to treat the water in cooling towers to remove minerals (for example by chemical precipitation or by using reverse osmosis), but this is costly and rarely practiced. The practical manner to manage concentration of minerals in blowdown water is by monitoring the levels during reuse of the water. When the levels become high, but still below the use threshold, the water is no longer reused. At this point, the water is cleaned to meet all acceptable irrigation criteria and discharged from the holding/treatment tank to the landscape irrigation.

### Real Time or Scheduled Water Quality and Quantity Monitoring

The complexity of water quality as a subject is reflected in the many types of measurements of water quality indicators. Some of the simple measurements listed below can be made on-site—temperature, pH, dissolved oxygen, conductivity, oxygen reduction potential (ORP)—in direct contact with the water source in question. More complex measurements that must be made in a lab setting require a water sample to be collected, preserved, and analyzed at another location. Water quantity measurements will be important to determine the amount and rate of water collected, monitored for quality and quantity, treated and used as the end-user may desire to know how much water is available for any uses contemplated and what, if any, adjustments can or should be made to improve system efficiency. Making these complex measurements are important to the engineering, design, operation and effectiveness of the integrated system. Water quality environmental monitoring programs will evaluate and manage some or all of the criteria listed.

| Chemical assessment | Physical assessment |
|---|---|
| conductivity (also see salinity) | pH |
| dissolved oxygen (DO) | temperature |
| nitrate-N | total suspended solids (TSS) |
| orthophosphates | turbidity |
| chemical oxygen demand (COD) | |
| biochemical oxygen demand (BOD) | |
| pesticides | |

Water quality is affected by biological, chemical, physical, and radiological constituents. In the United States, the Environmental Protection Agency (USEPA), in consort with local boards of health, sets the standards for drinking water quality, and these standards regulate the allowable type and concentrations of the constituents.

The key to providing safe water is having enough information available to make decisions, and that information has a cost. The water quality and quantity of the sources should be known in order to determine any treatment needs. They should also be known as the water is being delivered to the user through the collection and distribution system. The best monitoring technologies will include sufficient, accurate, and timely information at the lowest cost.

The technology innovations developed in the present invention includes an integrated system that will give instant information about water quality, quantity and process operational status from remote locations. The technology also consists of physical, chemical, biological and, eventually, radiological sensors and analyzers, remote computing platforms, software, communications, and a host computer. Radiation detection will be added as the technology matures. Continual on-line analysis of the data acquired by the system will produce critical information supportive of the decision-making process.

Based on the need for a cost-effective, comprehensive, water quality and quantity remote monitoring system, it is proposed to integrate and test a solution that does the following:
The system will provide complete coverage of the distribution system.
The system will provide an accurate, ongoing, strategic assessment of water quality and quantity throughout the system and help the operator to determine that an identified water quality or quantity change does or does not represent a real problem.
The system will notify the operator when and where an intentional or accidental chemical, biological, or radiological contamination event is occurring.
The system will be cost-effective (low capital/cost, low maintenance), flexible, expandable, rugged, and dependable) in order to permit complete area-wide coverage of the water system.

### Selected Sensor/Instrument Summary

Different aspects of water quality are important depending on the end use. The following water quality characteristics or contaminants can be monitored and measured by the technologies described, which are be utilized by the present invention. Depending on water quality and the end use criteria, the present invention is dynamic in applications and may use all or some of the available monitoring and treatment technologies to achieve the desired end objective of water quality that will meet or exceed the regulatory and practical end use water quality standards. Other current or evolving monitoring technologies may also be utilized by the present invention to meet the needs of the end user.

### Residual Chlorine

Sensors measure the amount of chlorine dissolved in the water. Sensors exist for measuring elemental chorine, chloramines, and chlorine dioxide, all of which are used today to provide disinfection of water. Chorine attacks chemicals and biological organisms in the water, becoming tied up in the process. A drop in chorine indicates it is oxidizing something in the water. As discussed below, ORP levels will corroborate the chorine readings.

### Oxidation/Reduction Potential (ORP)

ORP measures the chemical potential of the water chemistry to oxidize or reduce chemicals introduced into the water. Chlorine is a strong oxidant and a disinfectant. The concentration of chlorine in the water and the oxidation potential should follow each other, i.e., if the chlorine concentration drops, so should the oxidation potential, and, if the chlorine concentration rises, so should the oxidation potential. Chlorine destroys chemicals and biota by oxidizing them. As long as there is sufficient chlorine in the water, the oxidation potential will be positive.

pH

The acidity or basicity of a solution, or pH, can be measured using standard pH probes and meters.

### Turbidity

Turbidity can be measured using in-line turbidity meters.

### Conductivity

Conductivity sensors measure, indirectly, the levels of total dissolved solids (TDS) in the water by measuring how well the water conducts electricity. Dissolved salts, as well as heavy metals, will increase electrical conductivity. Evaluation of the water quality is enabled by monitoring electrical conductivity of the water over time.

### Hydrocarbons

Hydrocarbons can be reliably measured in the water using UV Fluorometers. If hydrocarbons are a concern, the UV Fluorometers can measure hydrocarbons in the range of micrograms (parts per billion) and report changes in levels.

### Total Organic Carbon (TOC)

TOC analyzers measure all the carbon in the water, encompassing that contained in chemicals and biota. TOC analyzers are appropriate for detecting abnormal increases in TOC, which might represent contamination.

### Discrete Chemistries

Gas chromatographs (GC) and mass spectrometers (MS) offer the desired ability to identify organics specifically, but tend to be operationally demanding and are costly. The end user of the system described in the present invention can determine if these identifications are needed.

### Multiple Parameters—TOC, DOC, BTX, NO3, and NO2

Ultraviolet absorbance spectrometry (UV Absorbance) can identify inorganic chemicals such as chloramines, nitrates, phosphates, and ammonia, as well as total organic carbon (TOC), dissolved organic carbon (DOC), benzene, toluene, xylene (BTX), and some groups of organic chemicals. UV absorbance spectrometers can provide correlation for TOC and chemical oxygen demand (COD). UV absorbance spectrometers tend to cost less than GCs or MSs and give considerably more information than TOC analyzers. An ultra-violet absorbance spectrometer (UVAS) can be included to measure TOC, DOC, BTX, nitrates, and turbidity. The addition of carbon molecules to the water, whether from chemical or biological sources, will be recorded as an increase in TOC. DOC is the dissolved portion of TOC, and is representative of organic chemicals. BTX represents volatile organic compounds commonly found in hydrocarbons like gasoline and industrial solvents. Turbidity measures how turbid, or cloudy, the water is, and an increase in turbidity can represent a chemical emulsion, color change, or the introduction of particulate matter. The latter can be deceptive due to periodic shedding of the accumulated material adhering to the walls of the water pipes. This shedding can be caused by a water hammer from the sudden shutting of valves, or from a depressurization due to a water main break or hydrant flushing. Correlation of increased turbidity with normal maintenance activities and such occurrences as water main breaks is often possible, and it will be up to the operator to keep logs of such events.

An increase in TOC and/or DOC represents the addition of organic molecules to the water. A decrease in ORP and chlorine may be detected with an increase in TOC. An increase in TOC may indicate a biological contamination, and this should be correlated with information from the biological microorganism detection instrument. An increase in BTX will most certainly correlate with an increase in TOC and DOC.

### Biological Detection

The appropriate microorganism detection instrument detects and classifies parasitic protozoa (Cryptosporidium and Giardia) and bacteria (E. coli, Pseudomonas, Shigella, and Salmonella) in water in a real time, continuous basis. If an unclassified organism is detected, the instrument will categorize it as an ‘unknown’ and still provide an ‘alert’ if the threshold level is reached. The instrument is commercially available. Real time monitoring of microorganisms is a relatively new technology and the present invention recognizes the utility of real time analysis available for the end user.

### Total Dissolved Solids

Dissolved solids (atoms) are small, usually less than 8 ten thousandths of one micron in size. Some dissolved solids (e.g.—hard minerals, alkaline minerals, and sulfate among others) are harmless but may cause objectionable taste and scale problems. Others, such as lead, nitrate, sodium, fluoride, arsenic, mercury, etc., are harmful. The amount of these contaminants allowed in drinking water is limited by government standards. Total Dissolved Solids (TDS) refers to the overall amount of all dissolved solids found in any one tap water sample. Technologies are available to reduce TDS. The technology is fairly expensive, and management of TDS will be done primarily with monitoring and controls to keep the water quality within acceptable standards. TDS removal technologies are described below.

### Real Time or Scheduled Water Treatment Available Technologies

The water quality available for the end user of the present invention will depend on the engineered end use and management of the water quality to meet or exceed all regulatory compliance criteria. Depending on water quality and the end use criteria, the present invention is dynamic in applications and may use all or some of the and treatment technologies to achieve the desired end objective of water quality that will meet or exceed the regulatory and practical end use water quality standards. Secondary drinking water standards as defined by the US EPA may be an objective and target for the water quality in many of the use applications for the recovered water. The water engineering and water quality monitoring will allow the design and implementation of treatment systems to ensure the water meets the end use criteria.

The treatment of blow-down water will be necessary because blow-down water has a much higher mineral content than potable water supplied by the local water utility; often two to five times more minerals. The concentration of mineral is measured as Total Dissolved Solids (TDS). Most potable water in the U.S. has a TDS level of 100 to 350 parts per million (ppm), though some potable water can be as high as 500 ppm. Depending on the supply water and the cooling system operation; the blow-down water TDS can range from 500 to 1300 ppm. Besides minerals, the water might also contain algae, bacteria, or pathogens. There are often chemical additives put in the water to impede scaling, reduce ph levels, and kill biological contaminates. The possible presence of pathogens suggests the water should never come in contact with humans or be sprayed above ground. A review of the on-site water treatment regimen might reveal other possible hazards.

Water filtration is important for all irrigation systems. While some sprinkler systems are used to spread solids, such as treated sewage, the systems incorporate some form of filtration upstream of the system to prevent solids which are too large from entering the system. Filters can help extend the life of and lower the maintenance on, a sprinkler system. Filters are a necessity for drip systems in order to prevent emitters from becoming plugged. Even if small sand particles can pass through the system without clogging it, they cause wear on the equipment. Automatic valves contain very small water passageways, which can become plugged, resulting in the valve failing to either open or close. A small grain of sand caught in a spray nozzle can result in a dry, dead spot in a lawn.

While sand needs to be filtered out of the water, it is equally important to remove organic materials. Algae can grow inside the system, especially in drip tubes. Another situation occurs when a small piece of organic matter snags somewhere in a valve, fitting, emitter, or sprinkler. The organic matter by itself may not be large enough to be problematic. But soon another piece comes along and gets caught in the first. Then a very small grain of sand that would normally have passed through the system without problems becomes caught in the organic matter. Soon a large build-up of crud forms and the flow is blocked.

Real time treatment of water will allow use of captured water in a more effective and efficient way. Some of the real time water treatment technologies are listed below:

### Filter Technologies

Filters are broken down into different categories depending upon the method used to filter the water. A brief description of the most common types follows.

### Screen Filters

Screen filters are probably the most common filters and in most cases are the least expensive. Screen filters are excellent for removing hard particulates, such as sand, from water. They are inefficient at removing organic materials such as algae, mold, and plants. These amorphous materials tend to embed themselves into the screen material and are difficult to remove. In other cases they simply slide through the holes in the screen by temporarily deforming their shape.

A screen filter is cleaned by flushing the screen with a stream of water, or removing the screen and cleaning it by hand. Depending on the flush method used, the screen will probably have to be hand cleaned periodically to remove garbage not removed by flushing. Several methods of flushing are common. The simplest is a flush outlet. The outlet is opened and debris washes out of the flush outlet with the water. An improved variation on this is the directed-flow flush. Again, a flush outlet is opened, but in this case the structure of the filter is designed so that the flush flow rushes over the face of the screen sweeping the debris along with it. This is the most common method found in inexpensive filters. Typically more expensive, the most effective method of flushing is the backwash method: In this method the flush water is forced backwards through the screen. This is accomplished by either using two filters side-by-side (the clean water from one is used to flush the other) or by a form of back-flushing. In back-flushing the water is forced backwards through the screen by the water pressure in the system.

### Cartridge Filters

Cartridge filters are a variation of the other types listed here, depending on what the cartridge is made of. Most cartridges contain a paper filter which works just like a screen filter. Most also remove organics well because the paper texture is rough enough to snag the organic matter. While some cartridges can be washed, most of them are simply replaced when dirty.

### Media Filters

Media filters clean the water by forcing it through a container filled with a small, sharp edged, “media.” In most cases, the media material is uniform sized, crushed sand. The water passes through the small spaces between the media grains and the debris is stopped when it can't fit through these spaces. Media filters are best for removing organic material from the water. This is where the importance of the sharp edged media comes into play. These sharp edges snag the organics which would otherwise slither their way through the small spaces. River, beach, and creek sand tend to have rounded, soft edges and are not suitable for media filters. Media filters are the type of filters most commonly used for high volume cleaning of water from rivers and lakes. They are used by both large farms and municipal water systems. They most often are three to six foot diameter round tanks, and are almost always in groups of two or more. Media filters are cleaned by back-flushing. The force of the water going backwards through the filter lifts and separates the media which frees the debris and washes it out through a flush valve. Because a small amount of media is often washed out too, it is necessary periodically to add more to the filters. Because sand is not easily flushed out, media filters are not suitable for situations where the water contains a lot of sand. The additional sand will have to be removed by hand. Media filters must be carefully matched to the system flow rate for proper operation.

### Disk Filters

Disk filters are a cross between a screen filter and a media filter, with many of the advantages of both. Disk filters are good at removing both particulates, like sand, and organic matter. A disk filter consists of a stack of round disks. The face of each disk is covered with various sized small bumps. A close up view of the bumps reveals that each has a sharp pyramidal point on the top. Because of the bumps, the disks have tiny spaces between them when stacked together. The water is forced between the disks, and the particulates are filtered out because they won't fit through these gaps. The organics are snagged by the sharp points on the bumps. For automatic cleaning of the filter, the disks are separated from each other, which frees the debris to be flushed out through a flush outlet. Less expensive disk filters require the removal of the disks and manual cleaning.

### Centrifugal Filters

Also known as “sand separators,” centrifugal filters are primarily used for removing particulates, such as sand, from the water. They are ideal for situations where a lot of sand is present in the water, as they don't clog as quickly as other types of filters. The dirty water enters the filter where it is swirled around the inside of a cylinder. The centrifugal force causes the sand particles to move to the outside edge of the cylinder where they gradually slide down the side to a holding tank at the bottom. Centrifugal filters are reasonably inexpensive, simple, and effective at removing sand from water. Because many wells pump sand up along with the water, centrifugal filters are usually installed on large wells. Some centrifugal filters are designed to be installed inside the well. These typically are attached to the bottom of a submersible pump. Usually, a very small amount of sand passes through a centrifugal filter. For drip irrigation systems, a “backup” screen filter is applied as a safety precaution when using a centrifugal filter. A centrifugal filter used in combination with a media filter is an excellent combination. The centrifugal filter pulls out the sand, then the media filter removes the organics. This combination is often used in municipal water treatment where a third activated charcoal filter may be added to remove chemicals. Note that the centrifugal filter selection must be carefully matched against the system gallons per minute (GPM) or the filter will not work correctly. The manufacturer's sizing guidelines should be consulted when designing a centrifugal filtration system for an irrigation system.

### Water Treatment to Improve Water Quality

There are also various types of water treatments available to reach a goal for use of the water recovered by the present invention. A brief description of the most common types follows.

### Reverse Osmosis and Nanofiltration

Reverse osmosis (RO) is a pressure driven process that raises the water pressure on the high TDS side of the membrane (feed side) to well above the osmotic pressure and forces water to flow through the membrane to the low TDS side of the membrane (product side). The RO membrane permits the passage of water molecules but is a barrier to most of the dissolved solids in the water. As the source water flows along the membrane, the TDS is concentrated and finally discharged as a waste stream from the process. Nanofiltration (NF) is a similar process that works at lower pressure. RO systems can remove up to 90-95% of all TDS, while NF systems mainly remove divalent ions and organics. The RO and NF technologies are typically used after the water has been pretreated to remove organics, suspended solids, and metals that may oxidize or precipitate on the membranes. Pretreated water is then sent to an RO or NF system for desalination for drinking water, water reuse, or as part of a system to produce ultrapure water. RO is selected for indirect and direct potable water reuse applications because it provides an absolute barrier to bacteria and pyrogens and can remove pesticides while lowering the TDS concentration.

### Integrated Membrane Systems

Integrated membrane systems (IMS) consist of water treatment systems that use two or more water treatment technologies, including membranes, to meet various product water quality objectives. There are many IMSs that are successfully designed to treat water for multiple reuse applications, limited water supplies, or strict environmental discharge limits. All applications of IMS have helped the user avoid disposal of wastewater, while supplying usable water for the intended purposes of the end user. Combining different treatment technologies can help to maximize water recovery, achieve high water quality for water reuse, and minimize life-cycle costs. The use of IMS for water reuse is expected to grow substantially in the years to come.

### Water Disinfection Chlorinators

Chlorinators incorporate state-of-the-art technology and include gas, liquid and solid tablet chlorinators. Commercial equipment vendors provide pressure or vacuum chemical feed chlorination equipment, panel mounted system packages, plus any monitoring products (analyzers), maintenance supplies, replacement parts, repairs and services for all of our groundwater (and surface water) wastewater treatment and disinfection systems.

### Water Purification

Water purification is the process of removing undesirable chemicals, materials, and biological contaminants from raw water. The goal is to produce water fit for a specific purpose. Most water is purified for human consumption (drinking water) but water purification may also be designed for a variety of other purposes, including meeting the requirements of medical, pharmacology, chemical and industrial applications. In general, the methods used include physical process such as filtration and sedimentation, biological processes such as slow sand filters or activated sludge, chemical process such as flocculation and chlorination, and the use of electromagnetic radiation such as ultraviolet light.

The purification process of water may reduce the concentration of particulate matter including suspended particles, parasites, bacteria, algae, viruses, fungi, and a range of dissolved and particulate material derived from the minerals that water may have made contacted after falling as rain. The standards for drinking water quality are set by governmental or international standards. These standards typically set minimum and maximum concentrations of contaminants for the use of the water.

It is not possible to determine whether water is of an appropriate quality by visual examination. Simple procedures such as boiling or the use of a household activated carbon filter are not sufficient for treating all the possible contaminants that may be present in water from an unknown source. Even natural spring water—considered safe for all practical purposes in the 1800s—must now be tested before determining what kind of treatment, if any, is needed. Chemical analysis, while expensive, is the only way to obtain the information necessary for deciding on the appropriate method of purification.

### Utilization of the Recovered Water

Once the condensate or rain water is recovered, treated, and monitored, it can be put to a number of possible uses which are described below. This water recovery, treatment, monitoring and use of the water in an engineered and tailored system is the essence of the present invention. In fact, the project engineering will be benefited by a systems design based on information obtained from the end user. The information-gathering and development of each system can be accomplished with the following systems design and operation criteria.
Determine available water volume
Determine a water use program
Match the water use program with the regulatory water quality criteria
Conceptual Systems Design
   Water volume required per each design end use
      Irrigation
      Landscape water features
      Sanitary
      Carwash
      Wetland
      Ground water recharge
      Solar and thermal water applications
      Etc.
   Select monitoring technology per each design use
      Real time
      Scheduled check sampling and analysis
   Select treatment technology per each design use
      In-line
      In tank
   Integrate water volume and recovery sources, monitoring technology, treatment technology, all end uses into a conceptual design
   Evaluate the economic viability of the project based on cost-verses-benefit and decide to either continue project development or abort the project
   Permit system with the legal water authority
Prepare final design
   Control panel
   Water recovery plumbing
   Tank system
   Monitoring technology
   Treatment technology
   Water delivery system
      Integrate plumbing tie-in or design end use structures for permitting and construction
Construct system
Test controls and operations
De-bug system
Commission operating system

The following are some of the end uses for the recovered water.

### Irrigation and Landscape Features

Efficient use of water for irrigation is vitally important in water conservation. An important aspect of water conversation in irrigation involves the capture of water resources, the reutilization and recycling of water, and efficient use of water. The use of condensate water or rain water will promote efficient and effective use of water which now is largely discarded as waste water. Vegetation can be maintained and large water features, such as ponds, waterfalls and fountains can benefit from the use of the captured water. The system in the present invention can generate water in quantities above what are needed for landscape irrigation or other water features. Systems engineering will dictate water quality criteria for compliance and safe use of the water.

### Wetland Construction

If space permits, the water recovered by the methods described in the patent may be stored in a constructed wetland. The wetland can further purify wastewater through the adsorption of contaminants, the capture of suspended sediments by soil, and the incorporation of biological material into the ecosystem. The construction of wetlands provides a natural landscape featuring an ecosystem where plants and wildlife may contribute to wastewater treatment so long as lethally toxic contaminants are removed before water storage. The wetland may serve as a natural filter into the ground water reserve or simply act as a surface storage site. The wetland further serves a role in flood and erosion control due to the stability of the ecosystem during water influx. Construction of wetlands is ideal for humid climates where evaporative water loss is not of concern and excess precipitation calls for a quick storage solution for flood control.

### Aquifer Recharge

The collected water from the processes described here can be stored underground over a long term through the recharge of aquifers below the water table. Water banking in the ground allows storage in times of water surplus and allocation of water in times of need. The primary advantage of groundwater storage over surface storage, such as reservoirs, is the absence of evaporation. This storage mechanism is ideal for arid climates where the evaporation rate is high and precipitation is low. A natural aquifer recharge mechanism allows for filtration of secondary contaminants such as nutrients and organic matter through, soil; however, primary contamination including chemicals and heavy metals diminish ground water quality if not manually removed. Storm water and irrigation return will naturally replenish the aquifer located below the operation site. In the case of recovery of HVAC condensate and refrigeration blowdown, water described in the patent, all contaminants are removed prior to storage, so artificial recharge through direct injection wells would accommodate an expedited infiltration process to the aquifer.

### Sanitary Facilities for Human Use

Water generated from the system described in the present invention can be used for flushing of sanitary facilities. Of course, the plumbing system be properly designed and maintained to prevent the water it carries from being a source of contamination to food, potable water supplies, equipment or utensils or otherwise creating an unsanitary condition. Once this is accomplished, the recovered water used for sanitary facilities frees up potable water for other beneficial uses with significant financial savings.

### Other Uses

The condensate and rainwater captured by the system described in the present invention can be put to a number of other uses which may include, but are not limited to, carwash facilities, fire water storage, solar thermal power generation, and makeup water for industrial application. Water captured by one owner might also be available for use by an adjacent property owner or user.

### SUMMARY OF THE INVENTION

The invention is fully integrated equipment and process technologies for rain water, HVAC condensate and refrigeration blowdown/bleed water collection, conservation, and reutilization coupled with an irrigation system. Captured water from rain, HVAC condensate and refrigeration blowdown/bleed blowdown is recycled and reutilized in mechanical processes as a conservation technology. The water is continuously monitored, or monitored on a scheduled basis, for contaminants and automatically cleaned though treatment technologies to meet health and safety acceptable standards for irrigation use or other uses. The water is stored and ultimately directed to efficient uses including landscape water features and irrigation, sanitary sewage flushing, wetland construction or aquifer recharge and a myriad of other possibilities. The water volume and flow rate is also monitored.

The present invention includes the integrated components of: the water collection system, the water storage vessels, the water recycling system, the water quantity and quality monitoring system, the water sediment filtering system, the water cleaning system, and the distribution of the water to the end uses. The water recycling system will employ monitoring techniques to ensure that the recycled water containment levels remain below use threshold. The water cleaning system may include standard filtering, advance micro-filtering, chemical treatment and/or biologic treatment. Depending on water quality and the end use criteria, the present invention is dynamic in applications and may use all or some of the available monitoring and treatment technologies to achieve the desired end objective of water quality that will meet or exceed the regulatory and practical end use water quality standards. The water storage and treatment tanks may be a series of tanks connected by plumbing or a single large tank with isolated cells to segregate the water based on water quality and distribution uses. The storage may also be in natural holding locations such as an underground aquifer or constructed wetland which will further contribute to water treatment by natural means.

The novel equipment design and integrated process results in efficient water conservation and utilization that has significant economic benefits during use. The water savings is an environmentally sound practice that uses engineering principals of mass and energy conservation

The quality of the captured water is managed to be suitable for irrigation without treatment because blowdown water systems may employ a water treatment component. Based on engineering economics, however, the water produced by the HVAC and blowdown would likely be reused three or four times in the refrigeration blowdown/bleed unit and then analyzed, cleaned and used for landscape irrigation or other applications depending on the regulatory criteria for the use.

A water mass balance study is performed on each facility to evaluate the optimum water and energy conversation plan. In many cases, excess water availability will allow the option of selling landscape irrigation water to neighbors. If the water mass balance has a deficit of water because of high water treatment costs to meet landscape irrigation criteria, then make-up water will be purchased and added to the system. An overall high level of conservation will still be achieved when employing the present invention.

### DRAWINGS

FIG. 1 shows the single tank with integrated equipment and process technologies for rain water, HVAC condensate and refrigeration blowdown/bleed water collection, conservation, and reutilization coupled with an irrigation system.

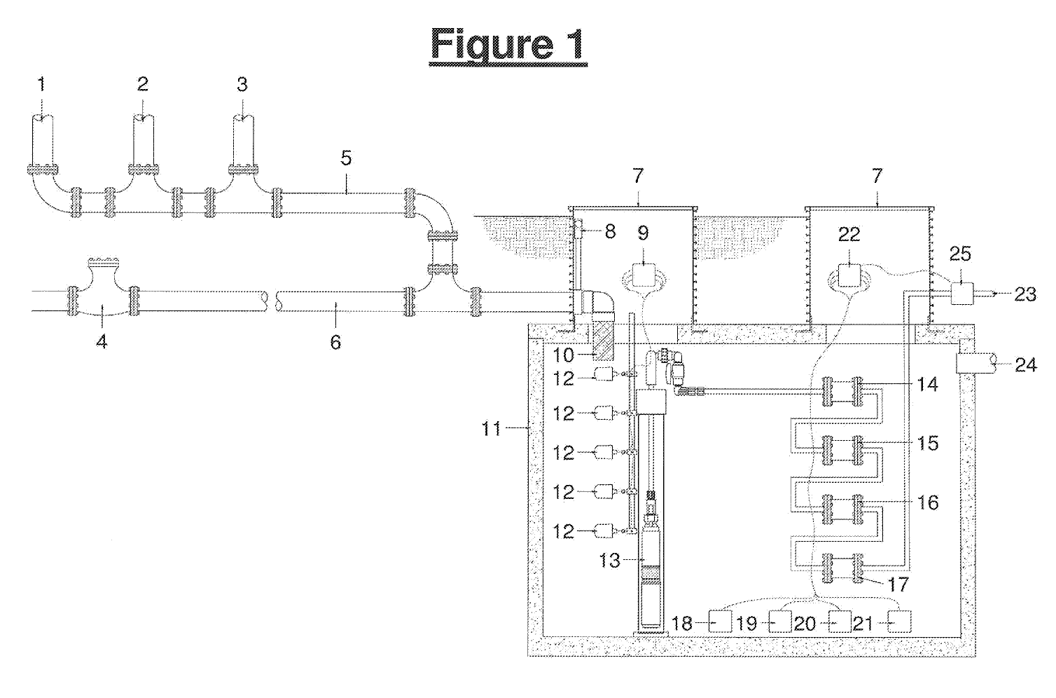

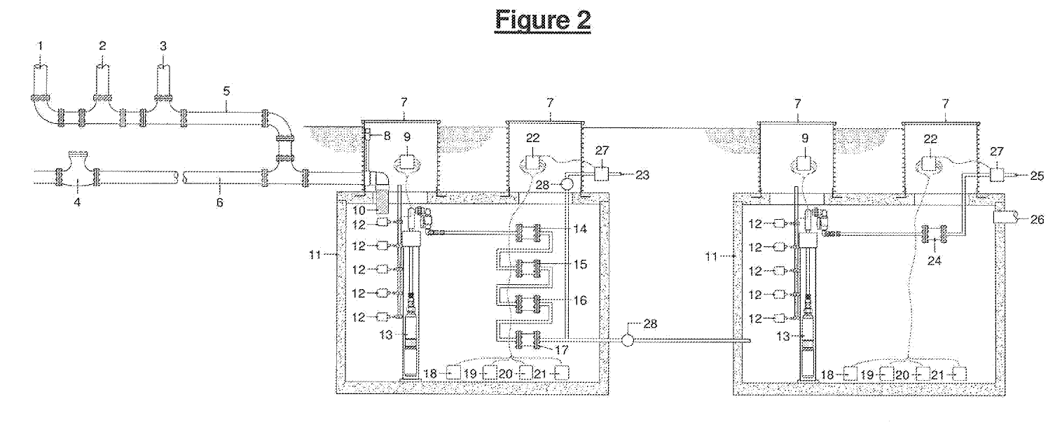

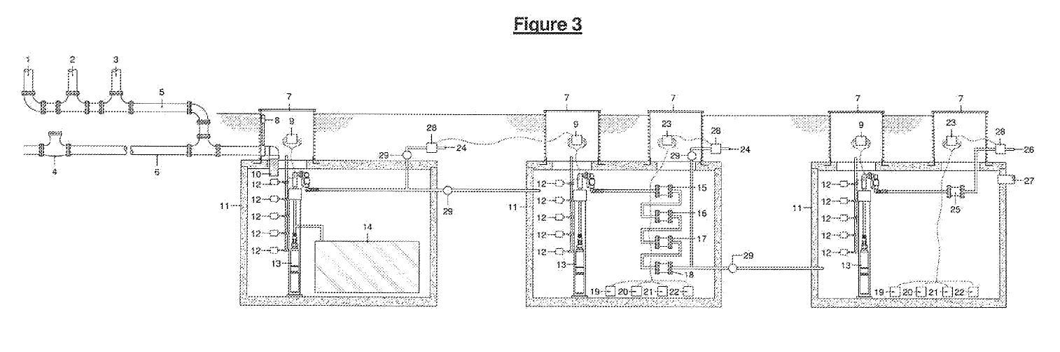

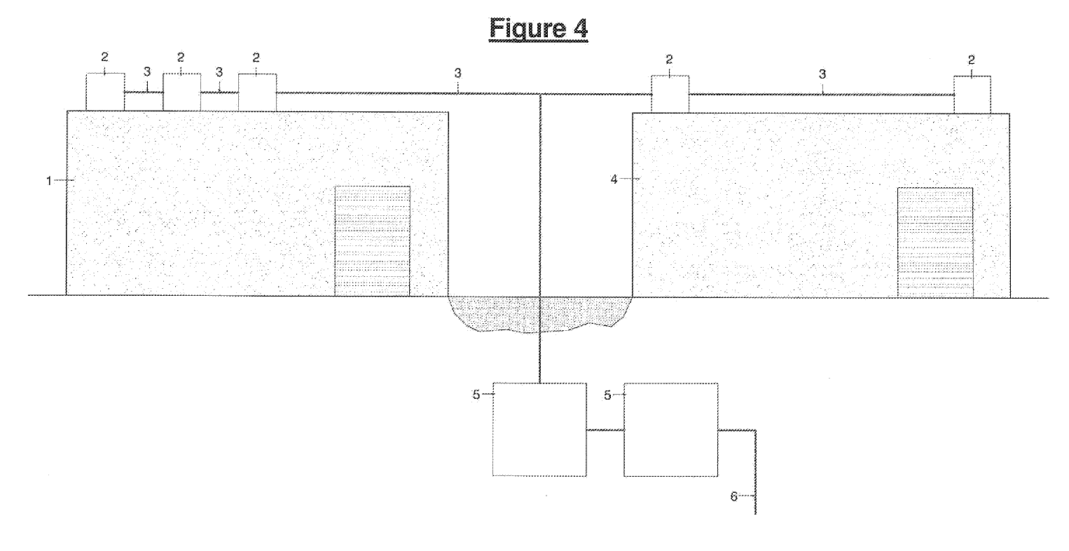

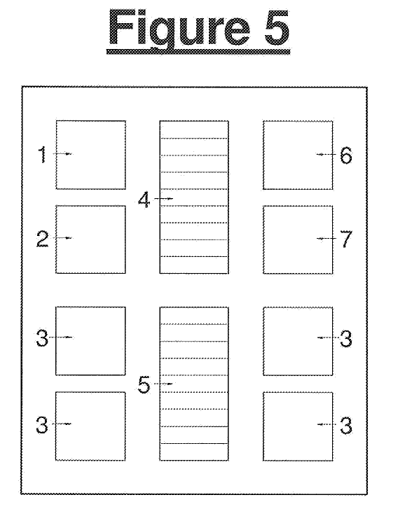

FIG. 1:
1. Rainwater collection
2. Blow down collection
3. Condensate collection
4. Low water control valve
5. Water transport pipe to the tank
6. From backup potable water source
7. Access vault
8. AC power connection
9. Splice box, electronic data monitoring & controls
10. Sediment filter
11. Underground water storage tank
12. Water level indicator float
13. High head pump in universal flow inducer
14. Water quality treatment system 1
15. Water quality treatment system 2
16. Water quality treatment system 3
17. Water quality treatment system 4
18. Water quality monitoring system 1
19. Water quality monitoring system 2
20. Water quality monitoring system 3
21. Water quality monitoring system 4
22. Data collection module
23. Supply to on site water usage
24. Overflow
25. In-line water quality monitoring

FIG. 2 shows a duel cell tank with integrated equipment and process technologies for rain water, HVAC condensate and refrigeration blowdown/bleed water collection, conservation, and reutilization coupled with an irrigation system. The duel cell technology allows for segregation of the reclaimed water and the cleaned water for reuse and for landscape irrigation.

FIG. 2:
1. Rainwater collection inflow pipe
2. Blow down collection inflow pipe
3. Condensate collection inflow pipe
4. Low water control valve
5. Water transport pipe to the tank
6. From backup potable water source
7. Access vault
8. AC power connection
9. Splice box, electronic data monitoring & controls
10. Sediment filter
11. Underground water storage tank
12. Water level indicator float
13. High head pump in universal flow inducer
14. Water quality treatment system 1
15. Water quality treatment system 2
16. Water quality treatment system 3
17. Water quality treatment system 4
18. Water quality monitoring system 1
19. Water quality monitoring system 2
20. Water quality monitoring system 3
21. Water quality monitoring system 4
22. Data collection module
23. Supply to on site water usage
24. Water quality treatment system 5
25. Supply to on site water usage with additional treatment requirements
26. Overflow
27. In-line water quality monitoring
28. Valve

FIG. 3 shows a three cell tank with integrated equipment and process technologies for rain water, HVAC condensate and refrigeration blowdown/bleed water collection, conservation, and reutilization coupled with an irrigation system. The three cell technology allows for segregation of the reclaimed water, where the first cell is incoming process water, a second cell contains mid grade cleaned water for process reuse, and a third cell for finish grade cleaned water for reuse and for landscape irrigation.
1. Rainwater collection inflow pipe
2. Blow down collection inflow pipe
3. Condensate collection inflow pipe
4. Low water control valve
5. Water transport pipe to the tank
6. From backup potable water source
7. Access vault
8. AC power connection
9. Splice box, electronic data monitoring & controls
10. Sediment filter
11. Underground water storage tank
12. Water level indicator float
13. High head pump in universal flow inducer
14. Sand/Oil Separator
15. Water quality treatment system 1
16. Water quality treatment system 2
17. Water quality treatment system 3
18. Water quality treatment system 4
19. Water quality monitoring system 1
20. Water quality monitoring system 2
21. Water quality monitoring system 3
22. Water quality monitoring system 4
23. Data collection module
24. Supply to on site water usage
25. Water quality treatment system 5
26. Supply to on site water usage with additional treatment requirements
27. Overflow
28. In-line water quality monitoring
29. Valve

FIG. 4 shows the water collection systems from one or more buildings and the tank system for water storage, monitoring, treatment and deployment to the end use.
1. Store/warehouse
2. Rooftop unit
3. Condensate/blow down collection lines
4. Secondary store/warehouse
5. Monitoring, treatment & deployment tank
6. Supply to on site water usage

FIG. 5 shows the electronic and chemical monitoring systems that sense and regulate water quality, quantity and distribution.
1. Water/volume or level
2. Inlet water flow rate
3. Future additional module
4. Primary water quality monitoring
5. Primary water treatment control systems
6. Water distribution control systems
7. Data sending unit

### DESCRIPTION OF THE PREFERRED EMBODIMENT

The invention is a fully integrated engineered system that includes equipment and process technologies for rain water, HVAC condensate and refrigeration blowdown/bleed water collection, conservation, and reutilization coupled with end use planning for recovered water. The water generated from air conditioning and refrigeration condensate can amount to substantial quantities. For example, an air conditioned 100,000 square foot warehouse or commercial retail store in southern California will typically generate several millions of gallons of condensate per year. If the facility has refrigeration or chiller units for food storage, then the refrigeration condensate generated would also be several millions of gallons per year. The condensate water that is presently generated is routinely disposed of into the either the storm drain or the waste water drain. The quantities of water that are available for capture and use make the present invention economically viable, as well as a superior conservation technology. In the present invention, the captured water from rain, HVAC condensate and refrigeration blowdown/bleed blowdown is recycled and reutilized in mechanical processes as a conservation technology. The water quantity and quality is monitored in real time or on a scheduled basis for contaminants and automatically cleaned by system technologies to meet healthy and safety acceptable standards for irrigation use, fire water holding tanks, injection into the local groundwater, recycling back to the plumbing appliances in the building, or other industrial or commercial or private uses.

The present invention includes the integrations of the following components into a novel engineered system: 1) Water collection from air conditioning and refrigeration units and rain water; 2) The custom design, engineering and implementation of a real time or scheduled water monitoring system to ensure water quality standards are met with respect to the end use of the recovered water; 3) The custom design, engineering and implementation of a real time or scheduled water treatment system to ensure water quality standards are met with respect to the end use of the recovered water; and 4) Utilization of the recovered water to the engineered industrial, commercial or private use.

The water is stored in surface or underground tanks or in nearby land waters and ultimately directed to efficient uses such that the end use plan dictates the required water quality and then an engineered system provides the correct water monitoring and water treatment technologies to achieve the end use criteria. The water recycling system will employ monitoring techniques to ensure that the recycled water containment levels remain below use threshold and the water cleaning system may include standard filtration technologies, advance micro-filtering, chemical treatment, biological treatment or mechanical treatment. Depending on quality of the captured water and the end use criteria, the present invention is dynamic in applications and may use all or some of the available monitoring and treatment technologies to achieve the desired end objective of water quality that will meet or exceed the regulatory and practical end use water quality standards. The end use of the water will include a myriad of applications wherein the quality of the water will be managed to match the regulatory criteria for the use.

What is claimed is:

1. The invention is fully integrated equipment and process technologies for rain water, HVAC condensate and refrigeration blowdown/bleed water collection, conservation, and reutilization coupled with end use planning for recovered water, wherein the captured water from rain, HVAC condensate and refrigeration blowdown/bleed blowdown is recycled and reutilized in mechanical processes as a conservation technology by recognizing and utilizing the large volumes of water generated by rain water collection and HVAC condensate, refrigeration blowdown/bleed water collection (in many cases measured in millions of gallons per year); the water is monitored for quantity and flow rate as well as for contaminants and is automatically cleaned though filtration and chemical treatment to meet healthy and safety acceptable standard for irrigation use, fire water holding tanks, injection into the local groundwater, recycling back to the plumbing appliances in the building, or other uses, such that the present invention includes the integrations of the following components into a novel engineered system: i) Water collection from air conditioning and refrigeration units and rain water; ii) The custom design, engineering and implementation of a real time or scheduled water monitoring system to ensure water quality standards are met with respect to the end use of the recovered water; iii) The custom design, engineering and implementation of a real time or scheduled water treatment system to ensure water quality standards are met with respect to the end use of the recovered water, wherein the present invention is dynamic in applications and may use all or some of the available monitoring and treatment technologies to achieve the desired end objective of water quality that will meet or exceed the regulatory and practical end use water quality standards; and iv) Utilization of the recovered water to the engineered end use, and the water is stored in the surface or underground tanks or in nearby land waters and ultimately directed to efficient uses such that the end use plan dictates the required water quality and then an engineered system provides the correct water monitoring and water treatment technologies to achieve the end use criteria and the water recycling system will employ monitoring techniques to ensure that the recycled water containment levels remain below use threshold and the water cleaning system may include filtering, advance micro-filtering, chemical treatment, biological treatment or mechanical treatment and the end use of the water will include a myriad of applications wherein the quality of the water will be managed to match the need and the regulatory criteria for the use.

2. A combined equipment and process technology that includes process water collection, water storage tank for rain water, HVAC condensate and refrigeration blowdown/bleed water collection, conservation, and reutilization coupled with an irrigation system as claimed in claim 1; the system includes automated contaminant monitoring equipment, water treatment equipment, water storage locations, and pump equipment for water transport to the end use which may be landscape irrigation, or fire water holding tanks or recycled back to a dual plumbing system in the building or other uses.

3. A combined equipment and process technology that includes process water collection, water storage tank for rain water, HVAC condensate and refrigeration blowdown/bleed water collection, conservation, and reutilization coupled with an irrigation system as claimed in claim 1, wherein the system contains an automated alarm and communication panel for systems analysis, engineering and adjustments.

4. A combined equipment and process technology that includes process water collection, water storage tank for rain water, HVAC condensate and refrigeration blowdown/bleed water collection, conservation, and reutilization coupled with an irrigation system as claimed in claim 1, wherein the process technology that includes process water collection, a multi-cell water storage tank having three or more cells for rain water, HVAC condensate and refrigeration blowdown/bleed water collection, conservation, and reutilization coupled with an irrigation system, the system includes automated contaminant monitoring equipment, water treatment equipment and pump equipment for water transport to the end use which may be landscape irrigation, or fire water holding tanks or recycled back to a dual plumbing system in the building or other industrial, commercial or private uses;

5. A combined equipment and process technology that includes process water collection, an underground storage aquifer for rain water, HVAC condensate and refrigeration blowdown/bleed water collection, conservation, and reutilization coupled with an irrigation system as claimed in claim 1, wherein the pretreated water is rapidly injected into the aquifer.

6. A combined equipment and process technology that includes process water collection, an underground storage aquifer for rain water, HVAC condensate and refrigeration blowdown/bleed water collection, conservation, and reutilization coupled with an irrigation system as claimed in claim 1, wherein the water is filtered through the ground during slow recharge.

7. A combined equipment and process technology that includes process water collection, a constructed wetland for storage and treatment of rain water, HVAC condensate and refrigeration blowdown/bleed water collection, conservation, and reutilization coupled with an irrigation system as claimed in claim 1, wherein the pretreated water is stored in the constructed wetland.

8. A combined equipment and process technology that includes process water collection, a constructed wetland for storage and treatment of rain water, HVAC condensate and refrigeration blowdown/bleed water collection, conservation, and reutilization coupled with an irrigation system as claimed in claim 1, wherein the water is treated by natural mechanisms of the wetland.

9. A combined equipment and process technology that includes process water collection, a constructed wetland for storage and treatment of rain water, HVAC condensate and refrigeration blowdown/bleed water collection, conservation, and reutilization coupled with an irrigation system as claimed in claim 1, wherein the water collection system collects water from multiple HVAC condensate and refrigeration blowdown/bleed facility units.

10. A combined equipment and process technology that includes process water collection, a constructed wetland for storage and treatment of rain water, HVAC condensate and refrigeration blowdown/bleed water collection, conservation, and reutilization coupled with an irrigation system as claimed in claim 1, wherein the water collection system collects water from multiple HVAC condensate and refrigeration blowdown/bleed facility units and wherein water is collected from several buildings to a central water collection, treatment, and redistribution process facility.

11. A combined equipment and process technology that includes process water collection, a two or more water storage vessels for rain water, HVAC condensate and refrigeration blowdown/bleed water collection, conservation, and reutilization the water storage vessels may be a single cell of may have multiple cells wherein the vessels are coupled with an irrigation system, the system includes automated or scheduled contaminant water quantity monitoring equipment, water treatment equipment and pump equipment for water transport to the end use which may be landscape irrigation, or fire water holding tanks or recycled back to a dual plumbing system in the building or other industrial, commercial or private uses.

12. A combined equipment and process technology that includes process water collection, water storage tank for rain water, HVAC condensate and refrigeration blowdown/bleed water collection, conservation, and reutilization coupled with an irrigation system as claimed in claim 11; coupled with an irrigation system, the system includes automated contaminant monitoring equipment, water treatment equipment, water storage locations, and pump equipment for water transport to the end use which may be landscape irrigation, or fire water holding tanks or recycled back to a dual plumbing system in the building or other industrial, commercial or private uses.
